(19) United States
(12) Patent Application Publication
(10) Pub. No.: US 2020/0256386 A1
(43) Pub. Date: Aug. 13, 2020

(54) ANTI-FRICTION BEARING CAGE, METHOD FOR PRODUCING AN ANTI-FRICTION BEARING CAGE, AND USE OF A SLIDE

(71) Applicant: Schaeffler Technologies AG & Co. KG, Herzogenaurach (DE)

(72) Inventors: Horst Arnet, Lauf a.d. Pegnitz (DE); Robert Dressel, Gremsdorf (DE); Manuel Winkler, Pommersfelden (DE); Harald Zwosta, Wachenroth (DE); Claudia Kacer, Nürnberg (DE)

(73) Assignee: Schaeffler Technologies AG & Co. KG, Herzogenaurach (DE)

(21) Appl. No.: 16/756,238

(22) PCT Filed: Oct. 29, 2018
(86) PCT No.: PCT/DE2018/100882

§ 371 Date: Apr. 15, 2020

(30) Foreign Application Priority Data
Nov. 3, 2017 (DE) 10 2017 125 700.4

(51) Int. Cl. F16C 33/38; F16C 19/06

(52) U.S. Cl. CPC F16C 33/3887; F16C 19/06

(57) ABSTRACT

An anti-friction bearing cage for an anti-friction bearing includes a cage ring with an inner radius, a first cage bar, a second cage bar, and a receiving pocket delimited by the cage ring and the cage bars. The first cage bar projects from the cage ring and includes a first side flank with a first part surface extending in a demolding direction for a common slide and a second part surface arranged adjoining the inner radius. The second cage bar projects from the cage ring and is successive to the first cage bar in the circumferential direction. The second cage bar has a second side flank, pointing towards the first side flank in a tangential direction, with a third part surface extending in the demolding direction and parallel to the first part surface in a part region, and a fourth part surface arranged at a spacing from the inner radius.

### CROSS-REFERENCE TO RELATED APPLICATIONS

This application is the United States National Phase of PCT Appin. No. PCT/DE2018/100882 filed Oct. 29, 2018, which claims priority to German Application No. DE102017125700.4 filed Nov. 3, 2017, the entire disclosures of which are incorporated by reference herein.

### TECHNICAL FIELD

The disclosure relates to an anti-friction bearing cage, a method for producing an anti-friction bearing cage and to the use of a slide by way of which rolling bodies of an anti-friction bearing are able to be positioned in the anti-friction bearing in a defined position relative to one another.

### BACKGROUND

It is known to produce an anti-friction bearing cage for an anti-friction bearing from plastics material by providing, for each receiving pocket provided for receiving a rolling body, one or multiple slides which can be displaced in the radial direction when the anti-friction bearing cage is demolded, as shown in U.S. Pat. No. 3,350,149 A. The receiving pockets realized by the respective slide are aligned, as a result, radially with respect to a center point of the anti-friction bearing cage.

DE 27 11 882 A1 describes a linear bushing with a cage which includes multiple guideways distributed on the circumference for receiving rows of balls. The cage is produced using the injection molding method, a side-symmetrical radial slide being used for molding two guideways.

### SUMMARY

According to the disclosure, an anti-friction bearing cage is provided for an anti-friction bearing, having at least one cage ring which extends in a closed manner in the circumferential direction and multiple cage bars which project in the axial direction from the cage ring. The at least one cage ring and in each case two cage bars delimit a receiving pocket for receiving one rolling body. Successive cage bars in the circumferential direction include a different cross sectional geometry for realizing at least two successive receiving pockets in the circumferential direction with parallel demolding directions for a common slide. In this case, the cage bars which delimit a receiving pocket include side flanks which point to one another, and each pair of side flanks which point to one another in the tangential direction include part surfaces which extend in the demolding direction and are parallel to one another at least in a part region. A first part surface is arranged adjoining an inner radius of the anti-friction bearing cage, and at least one second part surface is arranged at a spacing from the inner radius of the anti-friction bearing cage. The first part surface is arranged just on one of the side flanks which point to one another, whilst the at least one second part surface is arranged at least on the other of the side flanks which point to one another.

As a result of the type of arrangement of the first part surfaces, a receiving space for lubricant is provided between a rolling body arranged in the receiving pocket and the anti-friction bearing cage, which receiving space improves the lubrication of an anti-friction bearing. Said receiving space is realized here in a cost-efficient manner at the same time as the receiving pockets.

Instead of aligning two successive receiving pockets in the circumferential direction in the precise radial direction with respect to a center point of the anti-friction bearing cage and of the cage ring, the receiving pockets can be aligned substantially parallel to one another. To this end, the one receiving pocket can be aligned in such a manner that an imaginary center line at the center point of the anti-friction bearing cage extends somewhat offset toward one side as a secant, whilst the other receiving pocket can be aligned in such a manner that an imaginary center line at the center point of the anti-friction bearing cage extends somewhat offset toward an opposite side as a secant. As a result of the adjacent receiving pockets being aligned in a manner that is angled somewhat in such a manner with respect to the pure radial direction, that is to say by the receiving pockets being aligned in a common parallel direction with respect to one another, it is possible to mold and demold the receiving pockets at the same time by means of a common slide or a comparable tool. The number of slides in order to be able to realize the desired number of receiving pockets when the anti-friction bearing cage is produced, is able to be reduced as a result. This, in turn, reduces the number of actuators in order to be able to displace the slides in the radial direction. The anti-friction bearing cage can be produced, as a result, with a tool that is more cost-efficient to produce so that the production costs are able to be reduced.

The costs per unit are able to be reduced in particular in the case of the production of special bearings, which are produced in smaller quantities than standardized standard bearings which can be produced in larger numbers. Individually produced special machines with mounted rotary components with rather unusual dimensions and/or requirement profiles are able to be produced in a more cost-efficient manner as a result. As a result of aligning a number of adjacent receiving pockets in the same manner, the number of slides necessary to produce the receiving pockets is able to be reduced so that cost-efficient production of an anti-friction bearing cage is made possible.

The cage ring can be arranged in the radial direction between an inner ring and an outer ring of an anti-friction bearing, e.g., a radial bearing. One rolling body, which is designed, for example, as a ball, cylinder, roll, barrel, cone or needle and can roll off along the inner ring and/or the outer ring, is arranged in each of the receiving pockets which are delimited from one another in the circumferential direction by the cage bars. The respective anti-friction bearings arranged in the assigned receiving pockets can be arranged, as a result, on a common pitch circle radius at a defined distance to one another in the circumferential direction.

In an example embodiment, in each case two successive receiving pockets in the circumferential direction include a common demolding direction. As a result, multiple pairs of two receiving pockets can easily be provided one behind another in the circumferential direction in each case with a common demolding direction. The number of necessary slides for realizing the receiving pockets during a forming process, for example a plastics material injection molding process, can be halved as a result. However, it is also possible to provide three or more receiving pockets, each with a common demolding direction so that one common slide can produce a corresponding number of receiving pockets. For example, in the case of a large number of receiving pockets, correspondingly more receiving pockets can be produced by in each case one slide.

The demolding direction corresponds to the linear direction of movement of the slide when the slide is pulled out after realization of the receiving pockets from the plurality of receiving pockets for which the slide had been provided. In an example embodiment, the slide, or a center of gravity or a center line of the slide, is moved substantially in the radial direction, the radial movement of the slide along a movement direction which extends through the center point of the cage ring during demolding for the associated receiving pocket which is offset in the circumferential direction with respect to the center of gravity or to the center line of the slide, corresponding to a demolding direction which is angled with respect to the radial direction and extends during demolding substantially parallel to the movement direction of the slide offset by a defined distance in the tangential direction. A centroid of a cross sectional surface, viewed in the axial direction, of at least one receiving pocket is passed over by the slide during demolding in a demolding direction which points past the center point of the cage ring.

In an example embodiment, side flanks of successive cage bars in the circumferential direction, which side flanks point to one another in the tangential direction, are molded to a common predefined rolling radius for the positioning of a center point of a rolling body in the respective receiving pocket. It can be taken into account, in this connection, that the angling of the alignment of the receiving pocket corresponding to the development of a secant can result in a radial offset of the rolling bodies received in the respective receiving pockets in the case of a level straight flank design along the demolding direction. The three-dimensional shaping of the side flanks is chosen, however, in such a manner that the rotational axes of the rolling bodies in the installed state rest on a common pitch circle. In particular, the side flanks can realize in a part surface contact surfaces which are rounded, for example, for this reason, and abut flatly against the rolling body and, as a result, are able to force a certain positioning of the rolling body on a defined radius.

Side flanks of successive cage bars in the circumferential direction, which side flanks point to one another in the tangential direction, may each include a contact surface for abutment against the rolling body. The contact surfaces of various cage bars of the same receiving pocket are positioned on a different radius. A symmetrical or mirror-inverted shaping of the side flanks of the cage bars of a receiving pocket, which side flanks point to one another, cannot necessarily be ensured as a result of the demolding direction of the receiving pocket being angled with respect to the radial direction. A contact surface, which is, for example, rounded and/or adapted to the outer contour of the rolling body, can be realized on surface regions of the respective side flanks that are easily reachable for the slide as a result of the consciously asymmetric and non-mirror-inverted design of the side flanks. In said case, the contact surfaces are arranged offset to one another in the radial direction so that the rotational axis of the rolling body can be positioned easily on a defined rolling radius. As a result, the rolling bodies inserted in the receiving pockets can be easily arranged along a common pitch circle.

According to the disclosure, the side flanks of at least one pair of side flanks of successive cage bars in the circumferential direction, which side flanks point to one another in the tangential direction, include substantially parallel surfaces which extend in the demolding direction at least in a part region. The surface normals of the respective parallel surfaces can be substantially perpendicular to the demolding direction. The parallel surfaces can extend in an angled manner with respect to the demolding direction by a draft angle of, for example, between 1 and 5°. Apart from a draft angle provided where necessary, the side flanks, in particular outside of contact surfaces, can follow substantially the demolding direction. Unnecessary material input, which is not required for guiding the anti-friction bearing, can be saved as a result.

In an example embodiment, at least one cage bar includes side flanks which point away from one another in the tangential direction, each with surfaces which are substantially parallel to one another and which extend in the demolding direction at least in a part region. In an example embodiment, the cage bar which is molded between two receiving pockets realized by one common slide, can include part surfaces, e.g., second part surfaces, which are substantially parallel to one another and extend in the demolding direction. Where applicable, the part surfaces which extend substantially parallel to one another can extend in an angled manner with respect to the demolding direction by a draft angle of, for example, between 1 and 5°. As a result, the cage bar can include a defined minimum thickness so that a highly cone-shaped cross section with a thin wall thickness radially inside and a thick wall thickness radially outside can be at least reduced. The insertion and positioning of a rolling body within the receiving pocket can be improved as a result.

In an example embodiment, the two cage bars which are arranged to the side of two receiving pockets which are formed by one common slide, can include part surfaces, e.g., first part surfaces, which are parallel to one another and extend in the demolding direction.

At least one cage bar may include radially outside an attachment which projects in the tangential direction and/or in the circumferential direction, for covering a rolling body in a partially radial manner. The attachment can project, for example, in a nose-shaped manner and realize for the rolling body a contact surface which can be provided at least in part radially outside in relation to its center of gravity. Unwanted displacement of the rolling body to a larger rolling radius can be avoided as a result.

In an example embodiment, an indentation, which is delimited by the attachment and is undercut in the tangential direction, is substantially completely freely accessible in a demolding direction which is angled in relation to the radial direction of said cage bar. As the demolding direction along which the side flank, which realizes the indentation, extends at an angle to the radial direction, the slide can be pulled away from the side flank during demolding with a movement part in the tangential direction with reference to the indentation of the side flank. As a result, the indentation, viewed in the radial direction and undercut under the attachment, can actually be reached by the slide and left during demolding without overcoming a shoulder which covers the undercut.

The disclosure additionally relates to a method for producing an anti-friction bearing cage according to the disclosure which is realized and further developed as described above, for example as a result of injection molding. At least one slide which includes at least two continuations is prepared in a mold and a plastics material is poured into the mold. At least part of the continuations of the slide is surrounded by the plastics material to realize cage bars, and the slide is displaced substantially radially outward relative to the mold in order to demold at least two receiving pockets in the anti-friction bearing cage simultaneously. As a result of aligning a number of adjacent receiving pockets in the same manner, the number of slides necessary for producing the receiving pockets can be reduced so that a cost-efficient production of an anti-friction bearing cage is made possible. The respective continuation of the slide can realize a negative form for the respective receiving pocket.

In an example embodiment, the slide realizes a negative form of a cage bar between two adjacent continuations. As a result, the slide can also predefine the radial extension of the cage bar provided between the receiving pockets realized by the common slide. A component of the mold inserted between the continuations for shaping the cage bar can be avoided as a result so that a simple design is produced for the mold.

The disclosure additionally relates to the use of a slide which includes at least two continuations for realizing and demolding at least two receiving pockets in an anti-friction bearing cage which can be realized and further developed as described above, during a forming process, e.g., a plastics material injection molding process.

As a result of aligning a number of adjacent receiving pockets in the same manner, the number of slides necessary to produce the receiving pockets can be reduced so that cost-efficient production of an anti-friction bearing cage is made possible. The slide can be used, for example, in the method described above. A mold in which the slide is guided so as to be movable relatively in the radial direction is provided.

### BRIEF DESCRIPTION OF THE DRAWINGS

The disclosure is explained as an example below with reference to the accompanying drawings by way of exemplary embodiments, the features shown below being able to show an aspect of the disclosure both individually in each case and also in combination. The figures are as follows:

FIG. 1 shows a schematic sectional view of part of an anti-friction bearing cage during production,

FIG. 2 shows a schematic perspective view of the anti-friction bearing cage from FIG. 1 and

FIG. 3 shows a schematic view of a detail of the anti-friction bearing cage from FIG. 1.

### DETAILED DESCRIPTION

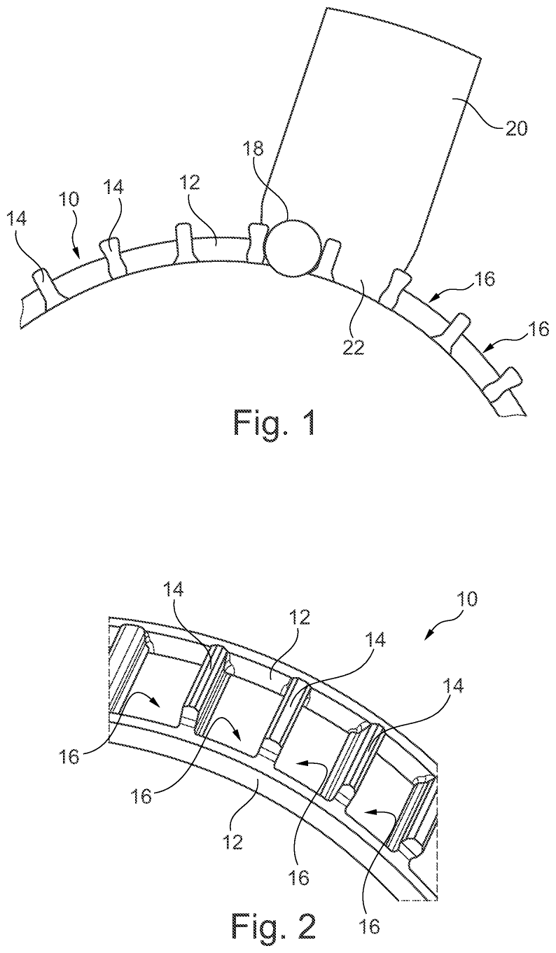

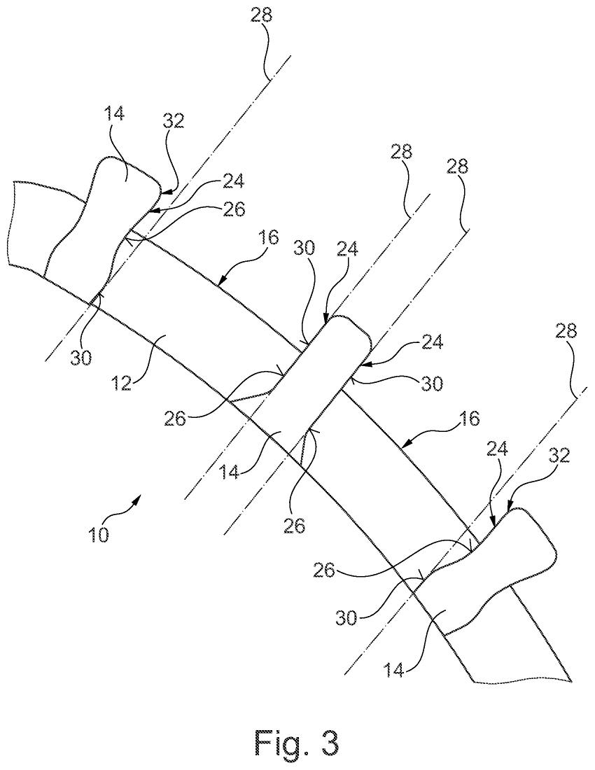

The anti-friction bearing cage 10 shown in FIG. 1 and FIG. 2 includes two cage rings 12 which rotate in the circumferential direction, are spaced apart from one another in the axial direction and are arranged one behind another, between which multiple cage bars 14 are arranged one behind another in the circumferential direction. The cage rings 12 and in each case two successive cage bars 14 in the circumferential direction delimit a receiving pocket 16, in each of which a rolling body 18 can be inserted. The cage bars 14, which delimit a receiving pocket 16, include side flanks 24 (ref. FIG. 3) which point to one another. The anti-friction bearing cage 10 includes an inner radius R.

The anti-friction bearing cage 10 can be produced by plastics material injection molding. In the exemplary embodiment shown, two successive receiving pockets 16 in the circumferential direction may be formed by a common slide 20 which is displaceable in the radial direction. To this end, the slide 20 includes two successive continuations 22 in the circumferential direction of the anti-friction bearing cage 10 which realize a negative form for the respective receiving pocket 16. A negative form for the cage bar 14, which is located between the receiving pockets 16 realized by the continuations 22 of the common slide 20, is realized additionally between the continuations 22.

As shown in particular in FIG. 3, the successive cage bars 14 in the circumferential direction are each molded differently, e.g., alternatingly. The cage bars 14 include the side flanks 24. In the exemplary embodiment shown, side flanks 24 include a rounded contact surface 26 for flat abutment against the rolling body 18 and part surfaces 30 which extend along a demolding direction 28, and the part surfaces 30 are molded by the same slide 20 extending substantially parallel to one another and to the demolding direction 28 of the slide 20. In this case, the part surfaces 30 can extend, where applicable, slightly angled with respect to the demolding direction 28 by a draft angle. As a result of the comparatively strong angling of the demolding direction 28 of the respective receiving pocket 16 with respect to the radial direction, it is even possible to realize the contact surface 26 on a side flank 24 of the receiving pocket 16 as an indentation which, when viewed in the radial direction, is undercut by a nose-shaped attachment 32, the indentation for the associated continuation 22 of the slide 20 not actually being arranged in an undercut manner. In addition, the contact surfaces 26 of various cage bars 14 of a receiving pocket 16 under consideration are positioned offset to one another in the radial direction in order to be able to hold the rotational axis of the rolling body 18 on a defined radius.

The cage bar 14, which is delimited on both sides by continuations 22 of the one slide 20 when the two receiving pockets 16 are molded at the same time, includes second part surfaces 30b which are arranged on both sides at a spacing from the inner radius R of the anti-friction bearing cage 10. The two cage bars 14, which adjoin the receiving pockets 16 at the side, each comprise on their side flank 24 pointing to the respective receiving pocket 16 a first part surface 30a which adjoins directly to the inner radius R of the anti-friction bearing cage 10. As a result, a receiving space B for lubricant is realized between the rolling body 18 and the first part surface 30a (reference FIG. 1).

### REFERENCE NUMERALS

10 Anti-friction bearing cage

12 Cage ring

14 Cage bar

16 Receiving pocket

18 Rolling body

20 Slide

22 Continuation

24 Side flank

26 Contact surface

28 Demolding direction

30 Part surface

30a First part surface

30b Second part surface

32 Attachment

R Inner radius

B Receiving space for lubricant

1.-9. (canceled)

10. An anti-friction bearing cage for an anti-friction bearing, comprising:
a cage ring, extending in a closed manner in a circumferential direction, comprising:
an inner radius; and
a first cage bar, projecting in an axial direction from the cage ring, comprising:
a first cross-sectional geometry; and
a first side flank comprising:
a first part surface extending in a demolding direction for a common slide; and
a second part surface arranged adjoining the inner radius;
a second cage bar, projecting in the axial direction from the cage ring and successive to the first cage bar in the circumferential direction, comprising:
a second cross-sectional geometry, different that the first cross-sectional geometry;
a second side flank, pointing towards the first side flank in a tangential direction, comprising:
a third part surface extending in the demolding direction and parallel to the first part surface in a part region; and
a fourth part surface arranged at a spacing from the inner radius; and
a receiving pocket for receiving a rolling body, delimited by the cage ring, the first cage bar, and the second cage bar.

11. The anti-friction bearing cage of claim 10, wherein the first side flank and the second side flank are molded to a common predefined rolling radius for positioning a center point of the rolling body in the receiving pocket.

12. The anti-friction bearing cage of claim 10, wherein:
the first side flank comprises a first contact surface, positioned on a first radius, for abutment against the rolling body; and
the second side flank comprises a second contact surface, positioned on a second radius, different than the first radius, for abutment against the rolling body.

13. The anti-friction bearing cage of claim 10, wherein:
the first cage bar comprises a third side flank, pointing away from the first side flank in the tangential direction, comprising a fifth part surface parallel to the first part surface and extending in the demolding direction in the part region; or
the second cage bar comprises a fourth side flank, pointing away from the second side flank in the tangential direction, comprising a sixth part surface parallel to the third part surface and extending in the demolding direction in the part region.

14. The anti-friction bearing cage of claim 10, wherein a one of the first cage bar or the second cage bar comprises a radially outside attachment, projecting in the tangential direction or the circumferential direction, for partially radially covering the rolling body.

15. The anti-friction bearing cage of claim 14, wherein the one comprises an indentation, delimited by the attachment, that is:
undercut in the tangential direction;
freely accessible in the demolding direction; and
angled in relation to a radial direction of one.

16. A method for producing the anti-friction bearing cage of claim 10 by injection molding, comprising the steps of:
preparing the common slide in a mold;
pouring a plastics material into the mold such that the common slide is at least partially surrounded by the plastics material to form the first cage bar or the second cage bar; and
displacing the common slide radially outward relative to the mold in order to simultaneously demold at least two receiving pockets.

17. The method of claim 16, wherein two adjacent common slides produce a negative form of the first cage bar or the second cage bar.

18. A slide comprising at least two continuations for realizing and demolding at least two receiving pockets in the anti-friction bearing cage of claim 10 in a plastics material by an injection molding process.
